(19) United States
(12) Patent Application Publication
(10) Pub. No.: US 2014/0224750 A1
(43) Pub. Date: Aug. 14, 2014

(54) Outdoor grill basket

(71) Applicants: Thomas Vogds, Denton, TX (US); Terri Vogds, Denton, TX (US)

(72) Inventors: Thomas Vogds, Denton, TX (US); Terri Vogds, Denton, TX (US)

(21) Appl. No.: 13/815,224

(22) Filed: Feb. 11, 2013

(51) Int. Cl. A47J 37/07

(52) U.S. Cl. CPC A47J 37/0786
USPC 211/13.1

(57) ABSTRACT

The invention disclosed herein is a grill basket designed and configured for use in Kamado style outdoor cookers and other types of outdoor cookers. The disclosed grill basket comprises three rings connected one on top of another in such a manner so that grills or other cooking surfaces containing meats and other items for cooking may be placed at various levels inside the Kamado style outdoor cooker. Placing the items to be cooked at various levels has the benefit of enabling cooking the items at various temperatures as desired. The invention disclosed herein is a tool for use with Kamado style cookers, among others, which increases the amount of cooking space, enables the cooking of a variety of foods at different temperatures, improves the grill master's ability to remove food from the Kamado style cooker, eases the grill master's task of changing cooking configurations within the Kamado style cooker during a cook and improves the grill master's ability to access the charcoal or other source of heat during a cook.

### CROSS-REFERENCE TO RELATED APPLICATIONS

This application claims priority to and benefit of U.S. Provisional Patent Application No. 61/633,536 filed on Feb. 13, 2012 which is incorporated by reference as if fully set forth herein.

### STATEMENT REGARDING FEDERALLY SPONSORED RESEARCH OR DEVELOPMENT

No part of the invention disclosed herein was the subject of federally sponsored research or development.

### THE NAMES OF THE PARTIES TO A JOINT RESEARCH AGREEMENT

None.

### REFERENCE TO A SEQUENCE LISTING

Not applicable.

### BACKGROUND OF THE INVENTION

1. Field

The field of the invention disclosed herein is the practice of outdoor cooking, grilling and/or smoking meat, vegetables and other foods over coals or an open fire. Specifically, the field of the invention disclosed herein is a tool which enables the grill master to prepare larger quantities of food, grill or smoke food at various temperatures, create varied cooking configurations, cook different types of food and easily move the food around the grill, remove the food and cooking configuration from the grill and improve access to the charcoal fuel when desired.

2. Description of the Related Art

The origins of cooking meats and other items over coals or an open flame probably extend to antiquity when earliest humans learned that game that had been hunted, killed and dressed took on a different taste and texture when left next to a fire or near coals. Meat began to be cooked on a stick or pole extending over the fire and rotated periodically. Some meats were buried in a pit with hot coals until done. Still other meats were smoked in a room with indirect heat and smoke cooking the meat. Gradually, the art of cooking over an open flame or coals has risen to the level of an art form in which complicated grills and exotic woods are used to cook the food. Today grills come in all shapes and sizes. Some grills are equipped with electric rotisseries to automatically turn the food while cooking. Other grills have temperature controls to monitor and maintain a steady heat for smooth and even cooking. Some grills are heated by natural gas. Other grills require charcoal or wood to provide the heat and cook the meat. One of the popular charcoal grills is the Kamado style cooker, such as The Big Green Egg®, a registered trademark of The Big Green Egg, Inc. Kamado style cookers are typically egg or oval shaped and made largely of ceramic, metal or other earth materials. Air vents located at the top and the bottom of Kamado style cooker control the amount of air which enters and leaves the grill, thereby regulating the heat intensity of the coals and/or fire. Charcoal, the primary fuel source, is added at the bottom of the Kamado style cooker and ignited to provide the heat source within the Kamado style cooker. The heat travels vertically in various amounts toward the top of the Kamado cooker and is dispersed throughout the inside of the Kamado cooker. How the grill master controls the rising heat and food placement impacts how fast or slow the food cooks in the Kamado style cooker.

This dispersal of the heat creates a temperature gradient which can be utilized by the grill master to cook foods faster or slower depending on where in the Kamado style cooker the food is placed. The heat from the coals is higher at the bottom of the Kamado style cooker than it is at the top of the Kamado style cooker. Therefore, food placed lower in the Kamado style cooker will cook faster than food placed higher up in the Kamado style cooker. Problems associated with the design of the Kamado style cooker are: the amount of cooking space, the difficulty in cooking a variety of foods at different temperatures, the difficulty in removing food from the Kamado style cooker, the difficulty accessing the charcoal and changing cooking configurations within the Kamado style cooker during the cook. What is needed in the art is a tool for the Kamado style cookers which increases the amount of cooking space, enables the cooking of a variety of foods at different temperatures and/or levels, eases the task of changing the cooking configuration within the Kamado style cooker, eases the removal of food from the Kamado style cooker and improves the grill master's ability to access the charcoal during a cook.

### BRIEF DESCRIPTION OF THE INVENTION

The invention disclosed herein is a tool for use with Kamado style cookers and other types of outdoor cookers which increases the amount of cooking space, enables the cooking of a variety of foods at different temperatures, improves the grill master's ability to remove food from the Kamado style cooker, eases the grill master's task of changing cooking configurations within the Kamado style cooker during a cook and improves the grill master's ability to access the charcoal or other source of heat during a cook. Specifically, the invention disclosed herein is a basket constructed from heat resistant metal tubing or solid rod designed and configured to fit inside Kamado style cookers. The invention disclosed herein is further designed and configured to support cooking surfaces such as a grill grid at different levels to cook food at various temperatures or position food at varying levels in the Kamado style cooker. The invention disclosed herein is further designed and configured to support a barrier plate made from earth material (ceramic) or metal. The plate is positioned between the charcoal and food to create a barrier which manipulates how the heat rises across the cooking surface(s). The invention disclosed herein collectively holds the barrier disk(s), cooking surface(s) and food. The invention disclosed herein is also equipped with handles located at the top of the basket to facilitate easy removal of the basket, grill grid(s), disk(s) and food collectively from the Kamado style cooker and as such give the grill master easy access to the charcoal. The grill basket may cook food at different levels and at different temperatures at the same time in the Kamado style cooker.

### BRIEF DESCRIPTION OF THE SEVERAL VIEWS OF THE INVENTION

A better understanding of the grill basket disclosed herein may be had by examination of the drawing/figures attached hereto.

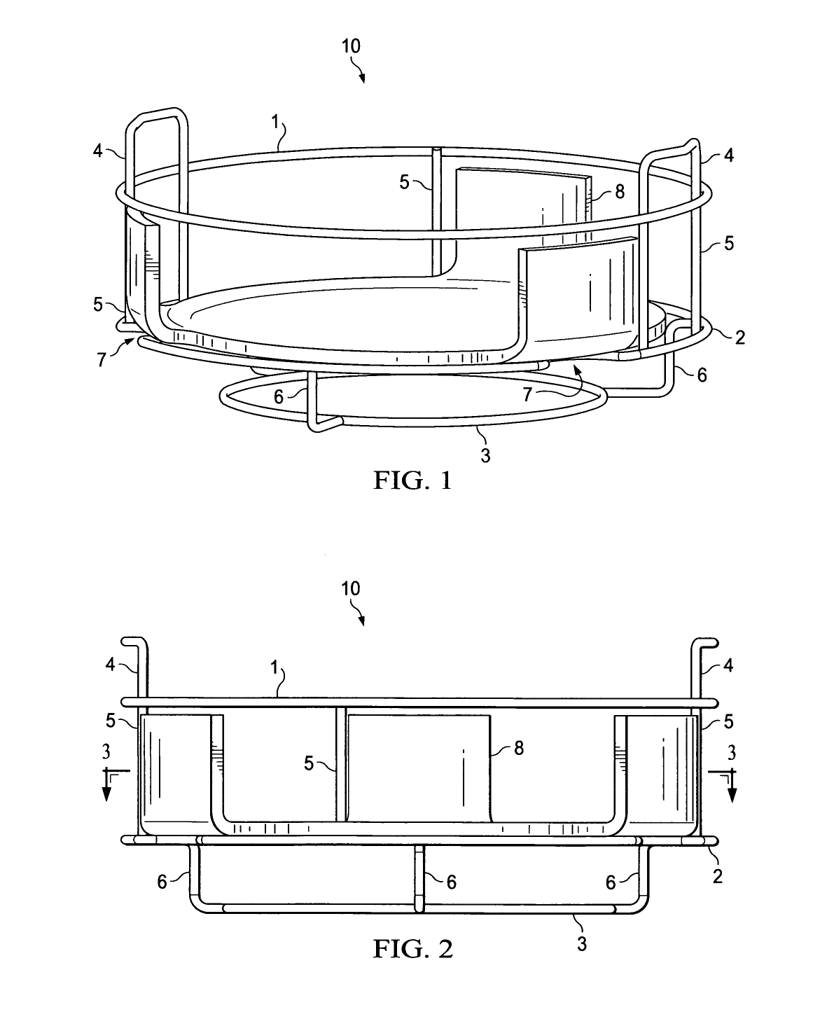

FIG. 1 is a side oblique view of the grill basket disclosed herein;

FIG. 2 is a side view of the grill basket disclosed herein;

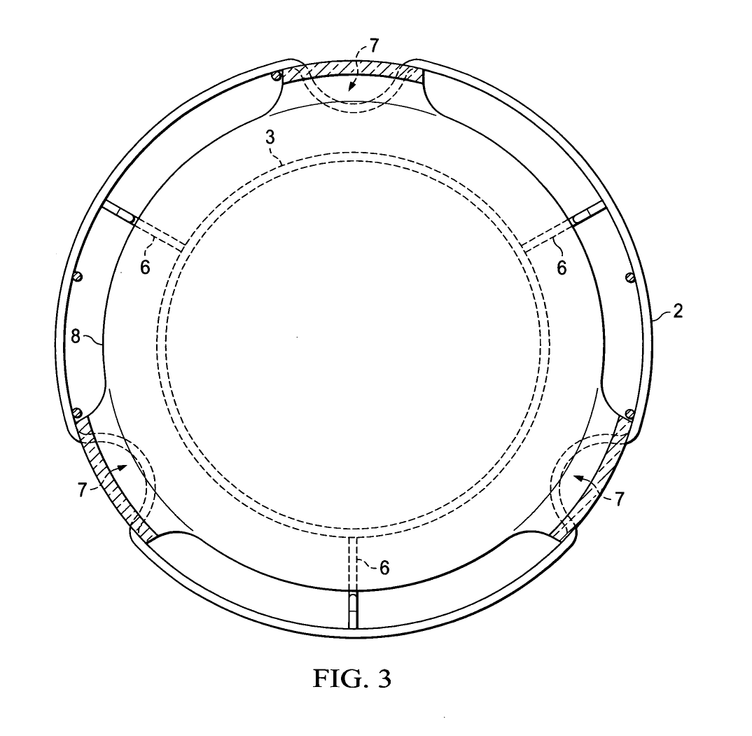

FIG. 3 is a top view of the middle ring and bottom ring of the grill basket disclosed herein;

### DETAILED DESCRIPTION OF THE INVENTION

The invention disclosed herein is a grill basket for use with the Kamado style cooker system and other types of outdoor cookers. The invention disclosed herein is a tool for use with Kamado style cookers, among others, which increases the amount of cooking space, enables the cooking of a variety of foods at different temperatures, improves the grill master's ability to remove food from the Kamado style cooker, eases the grill master's task of changing cooking configurations within the Kamado style cooker during a cook and improves the grill master's ability to access the charcoal or other source of heat during a cook.

As shown in FIG. 1, the grill basket 10 consists of three rings, a top ring 1, a middle ring 2 and a smaller bottom ring 3. The top ring 1 of the grill basket 10 is connected to the middle ring 2 by struts 5 which are welded to the top ring 1 and the middle ring 2. The middle ring 2 of the grill basket 10 is connected to the bottom ring 3 by another series of struts 6 configured to attach the smaller bottom ring 3 to the larger middle ring 2 of the grill basket 10. The struts 6 attaching the smaller bottom ring 3 are welded in place to fix the smaller bottom ring 3 to the middle ring 2. Handles 4 are place at 180° apart on the top ring 1 and extend above the top ring 1 of the grill basket 10 to facilitate removal of the grill basket 10 from the Kamado style cooker. The handles 4 are constructed as an extension of the struts 5 which connect the top ring 1 with the middle ring 2. The middle ring 2 is configured to have brackets 7 which are separated by 120° from each other on the middle ring 2. The purpose of the brackets 7 is to support a cooking surface such as a grill grid or barrier surface such as a ceramic plate 8.

As shown in FIG. 2 the grill basket 10 is composed of three rings, a top ring 1, a middle ring 2 and a smaller bottom ring 3. The top ring 1 is connected to the middle ring 2 by way of struts 5 which are welded in place to join top ring 1 with middle ring 2. The struts 5 are further configured to form handles 4 which extend above the top ring 1 for convenience in handling the grill basket 10. The middle ring 2 is connected to the smaller bottom ring 3 by additional struts 6 which are located 120° apart and are configured in such a manner so that the struts 6 are welded in place to join the smaller bottom ring 3 with the middle ring 2. A ceramic plate 8 may be positioned on middle ring 2, as shown, or optionally on top ring 1 or bottom ring 3.

Another view of the arrangement of the middle ring 2 with the smaller bottom ring 3 is shown in FIG. 3. The middle ring 2 is connected to the smaller bottom ring 3 by welding struts 6 located 120° apart from each other to connect the smaller bottom ring 3 with the middle ring 2. Three brackets 7 located 120° apart are placed on the middle ring 2 in such a manner that a cooking surface such as a grill grid or ceramic plate 8 may be supported by the brackets 7 creating additional cooking space or a plate may be supported by the brackets creating a barrier between the charcoal and cooking space in the Kamado style cooker.

In one embodiment of the grill basket disclosed herein is the ability to place meat on a cooking surface supported by the smaller bottom ring 3. By this embodiment meats may be placed closer to the source of heat, searing the outside of the meat. When the meat cooking on a surface supported by the smaller bottom ring 3 is sufficiently seared, the meat may be removed, a cooking surface placed on ring 1 or ring 2 and the meat placed on the elevated cooking surface. The meat placed on a cooking surface supported by middle ring 2 or top ring 1 will cook at a lower temperature than that of meat cooked on a cooking surface supported by the smaller bottom ring 3. If the grill master decided to move the meat from a cooking surface supported by the small bottom ring 3 to a cooking surface supported by the middle ring 2 for additional cooking at a lower temperature, the grill master could later move the meat from the cooking surface supported by the middle ring 2 to a cooking surface supported by the top ring 1 for still slower cooking at a lower temperature by transferring the meat from the middle ring 2 cooking surface to the top ring 1 cooking surface.

In other embodiments of the invention disclosed herein, a pizza or bread could be baked in the Kamado style cooker by placing solid cooking surfaces(s) on top ring 1, middle ring 2 or the smaller bottom ring 3 of the grill basket 10. In yet another embodiment, the grill master could wok cook by placing a wok on ring 2 or ring 3. In yet another embodiment, meat may be smoked and cooked by indirect heat by placing a ceramic plate 8 on the smaller bottom ring 3 or middle ring 2 which would block the direct flow of heat from the fire or coals. The struts 5 are configured in such alignment that should the grill master decide to remove the barrier from ring 2, the grill master can do so without handling the cooking surface or food on the ring 1 cooking surface. The grill master would lift the basket from the Kamado style cooker using the handles 4 and set the grill basket on a solid surface from which the grill master can slide the ceramic plate 8 or cooking surface in or out between the large opening between ring 1, ring 2 and struts 5. In another embodiment, several different foods could be cooked simultaneously at different temperatures on cooking surfaces placed on each of the three rings 1, 2, 3 of the grill basket 10.

The invention disclosed herein is subject to many modifications, including different sizes, additional modifications or accessories and additional rings. All of these embodiments are included within this specification and as described by the claims.

We claim:

1. A removable outdoor grill basket for Kamado style outdoor cookers which supports a plurality of cooking surfaces at various levels in said Kamado style outdoor cooker comprising:
a top ring supporting a cooking surface and to which two prehensile attachments are diametrically affixed to said top ring;
a middle ring of equal diameter to said top ring and connected in approximately parallel position to the underside of said top ring by a plurality of struts creating a space between said top ring and said bottom ring for a cooking surface containing food to be cooked;
a ceramic plate positioned on said middle ring;
a bottom ring of smaller diameter than said top ring or said middle ring and connected in approximately parallel position to the underside of said middle ring by a plurality of struts creating a space for a cooking surface containing food to be cooked.

2. A removable outdoor grill basket for outdoor cookers which supports a plurality of cooking surfaces at various levels in said outdoor cooker comprising:
a top ring supporting a cooking surface and to which two prehensile attachments are diametrically affixed to said top ring;
a middle ring of equal diameter to said top ring and connected in approximately parallel position to the underside of said top ring by a plurality of struts creating a space between said top ring and said bottom ring for a cooking surface containing food to be cooked;
a ceramic plate positioned on said middle ring;
a bottom ring of smaller diameter than said top ring or said middle ring and connected in approximately parallel position to the underside of said middle ring by a plurality of struts creating a space for a cooking surface containing food to be cooked.
